(19) United States
(12) Patent Application Publication
(10) Pub. No.: US 2024/0324073 A1
(43) Pub. Date: Sep. 26, 2024

(54) METHOD AND STRUCTURE OF CONFIGURING POLYSURFACE OBJECT

(71) Applicant: SHU-LIEN CHEN, Taichung City (TW)

(72) Inventor: SHU-LIEN CHEN, Taichung City (TW)

(21) Appl. No.: 18/599,290

(22) Filed: Mar. 8, 2024

(30) Foreign Application Priority Data
Mar. 24, 2023 (TW) 112111311

(51) Int. Cl. H05B 3/84; F21S 45/60

(52) U.S. Cl. CPC H05B 3/84; F21S 45/60

(57) ABSTRACT

A method of configuring a polysurface object contains: connecting a peripheral area of an electric heating film with a connection face of the polysurface object via a fixing unit. A heat unit of the electric heating film is spaced a distance from the connection face. Thereby, water mists forming on the inner fence of the lampshade or melting snows on the lampshade is avoidable. Preferably, the distance is not changeable based on the change of the curvature of the lampshade in the single curvature change or the multiple curvature changes to maintain a flatness of the heat unit, thus prevent bending and fracture of the multiple heating wires and an electric heat failure.

### TECHNICAL FIELD

The present disclosure relates to a method and a structure of configuring a polysurface object.

### BACKGROUND

A conventional polysurface object is comprised of at least two curved surfaces and is applied for a lampshade of a car headlight or a car front windshield, but it is not limited to car headlight or the car front windshield. For the convenience of following explanation, taking the lampshade of a car headlight as an example.

The lighting effect of the car headlight is crucial to driving safety. Water mist, frost, snow, etc. on the surface of the car headlights will affect the brightness of the car headlights. Frost and snow adhere to the outer surface of the lampshade because of weather factors, while water mists form on the inner surface of the lampshade. The reason for the formation of water mists is that after the car headlights are turned on, the temperature in a cavity increases, to cause the water vapor in the cavity to evaporate and flow, and when encountering the lower temperature lampshade, it condenses into water droplets.

To solve above-mentioned problem, CNA109323213 disclosed covering a conventionalelectric heating film on an inner wall of a lampshade of a car so as to conduct heat to the lampshade by using the electric heating film, thus evaporating steams, avoiding water mists forming on the inner wall of the lampshade and melting snows on the lampshade.

Referring to FIG. 1, the electric heating film 100 is plated or adhered on the inner wall of the lampshade 12. The electric heating film 100 can be plated on the inner wall of the lampshade 12 securely, but plating process is quite complicated, and a plating temperature of the lampshade 12 is reduced to cause slow manufacturing process and high fabrication cost. When the electric heating film 100 is adhered on the inner wall of the lampshade 12, it cannot be adhered on the lampshade 12 matingly because of curved surface of the lampshade 12, and multiple heating wires are bent and broken to cause a failure of the electric heating film 100.

The present invention has arisen to mitigate and/or obviate the afore-described disadvantages.

### SUMMARY

A primary aspect of the present invention is to provide a method of configuring a polysurface objectby which a heat unit of the electric heating film is spaced a distance from the connection face so that the distance is not changeable based on the change of the curvature of the lampshade in the single curvature change or the multiple curvature changes to maintain a flatness of the heat unit, thus prevent bending and fracture of the multiple heating wires and an electric heat failure.

Another aspect of the present invention is to provide a method of configuring a polysurface object by whichthe heat unit is adhered with the one or the multiple zones of the inner fence of the lampshade to reduce a bending of the inner fence of the polysurface object.

To obtain above-mentioned aspect, a method of configuring a polysurface objectprovided by the present invention contains:
connecting a peripheral area of an electric heating film with a connection face of the polysurface object via a fixing unit, and a heat unit of the electric heating film is spaced a distance from the connection face.

In another embodiment, a method of configuring a polysurface objectprovided by the present invention contains:
adhering the heat unit with the one or the multiple zones of the inner fence of the lampshade to reduce a bending of the inner fence of the polysurface object.

Other objects and features will be in part apparent and in part pointed out hereinafter.

### BRIEF DESCRIPTION OF THE DRAWINGS

FIG. 1 is a cross sectional view showing a conventional method of connecting a lampshade of a car with an electric heating film.

FIG. 2 is a cross sectional view showing the operation of an electric heating filmaccording to a firstembodiment of the present invention.

FIG. 3 is a plan view showing the assembly of the electric heating filmaccording to the firstembodiment of the present invention.

FIG. 4 is a cross sectional view showing the operation of an electric heating filmaccording to a secondembodiment of the present invention.

FIG. 5 is a plan view showing the assembly of the electric heating filmaccording to the secondembodiment of the present invention.

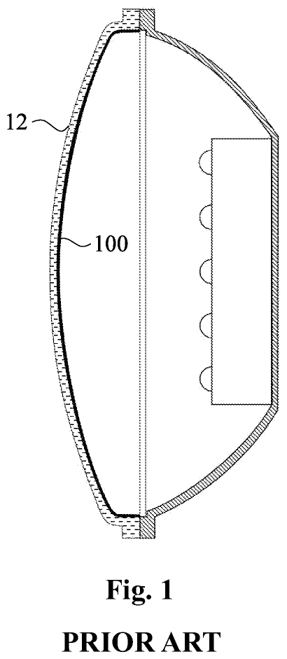

### DETAILED DESCRIPTION

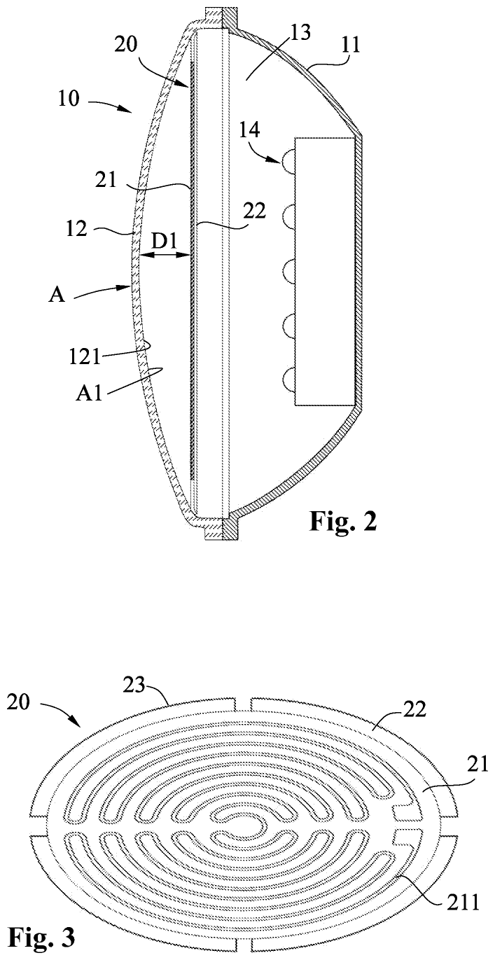

With reference to FIGS. 2 and 3, a method of configuring a polysurface object according to a first embodiment of the present invention comprises: connecting a peripheral area of an electric heating film 20 with a connection face A1 of the polysurface object A via a fixing unit 22, wherein a heat unit 21 of the electric heating film 20 is spaced a distance from the connection face A1.

The polysurface object A is comprised of at least two curved surfaces and is a lampshade of a car headlight or a car front windshield. In this embodiment, the polysurface object A is the lampshade of the car headlight.

The car headlight 10 includes a base 11, the lampshade 12 configured to cover on a front side of the base 11 and to define an interior space 13 with the base 11, wherein the lampshade 12 is the polysurface object A, a light emitter 14 fixed on the base 11 and located in the interior space 13, and the electric heating film 20 received in the lampshade 12 and located in the interior space 13. The base 11 also accommodates other elements of the car headlight 10, such as a circuit board or a coupling element configured to connect with a car shell. Since the base 11, the lampshade 12 and the electric heating film 20 are well-known art, further remarks are omitted.

The electric heating film 20 includes the heat unit 21 and the fixing unit 22 arranged on the peripheral area 23 of the electric heating film 20, and the fixing unit 22 has adhesive glue. The heat unit 21 is surrounded by the peripheral area 23 and includes at least one heating element, such as multiple heating wires 211 configured to heat the electric heating film 20. A conductive wire (not shown) of the heat unit 21 is connected with the circuit board of the car headlight 10 in a known art.

The peripheral area 23 of the electric heating film 20 is connected on an inner fence 121 (i.e. the connection face A1) of the lampshade 12 via the fixing unit 22, and the heat unit 21 is spaced a distance D1 from the inner fence 121 of the lampshade 12.

A curvature of the lampshade 12 is changeable in a single curvature change or multiple curvature changes based on headlight distribution requirements of the lampshade 12, and the distance D1 is changeable based on the change of the curvature of the lampshade 12, wherein a maximum value of the distance D1 is not over 2 cm, such that a temperature of the lampshade 12 is raised by using the heat unit 21 in a contactless manner to evaporate steams, thus avoiding water mists forming on the inner fence 121 of the lampshade 12 or melting snows on the lampshade 12. Preferably, the distance DI is not changeable based on the change of the curvature of the lampshade 12 in the single curvature change or the multiple curvature changes to maintain a flatness of the heat unit 21, thus prevent bending and fracture of the multiple heating wires 211 and an electric heat failure.

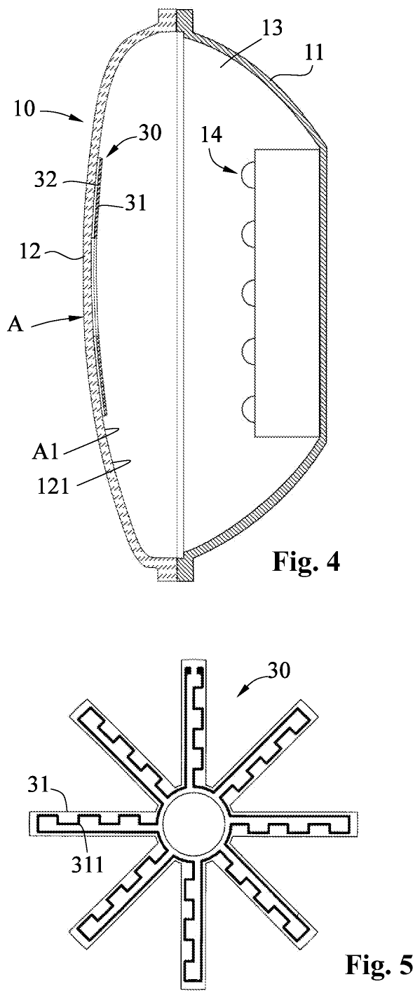

Referring to FIGS. 4 and 5, a method of configuring a polysurface object according to a second embodiment of the present invention comprises: connecting an electric heating film 20 with one or multiple partial zones of a connection face Al of the polysurface object A via a fixing unit 32.

The electric heating film 30 includes a heat unit 31 and a fixing unit 32. The heat unit 31 includes at least one heating element, such as multiple heating wires 311. A conductive wire (not shown) of the heat unit 31 is connected with the circuit board of the car headlight 10 in a known art. The fixing unit 32 is disposed on a back surface of the heat unit 31, and the fixing unit 32 has adhesive glue. The heat unit 31 is adhered with the one or the multiple zones of the inner fence 121 of the lampshade 12.

A curvature of the lampshade 12 is changeable in a single curvature change or multiple curvature changes based on headlight distribution requirements of the lampshade 12. The heat unit 31 is adhered with the one or the multiple zones of the inner fence 121 of the lampshade 12 so that the temperature of the lampshade 12 is raised in a contact manner by using the heat unit 31 to evaporate steams, thus avoiding water mists forming on the inner fence 121 of the lampshade 12 or melting snows on the lampshade 12. Preferably, the heat unit 31 is adhered with the one or the multiple zones of the inner fence 121 of the lampshade 12 to reduce a bending of the inner fence 121.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method of configuring a polysurface object comprising:
connecting a peripheral area of an electric heating film with a connection face of the polysurface object via a fixing unit, wherein a heat unit of the electric heating film is spaced a distance from the connection face.

2. The method as claimed in claim 1, wherein a maximum value of the distance is not over 2 cm.

3. The method as claimed in claim 1, wherein the fixing unit has adhesive glue.

4. A structure of configuring a polysurface object comprising:
thepolysurface object having a connection face;
an electric heating film including a peripheral area and a fixing unit arranged on the peripheral area of the electric heating film;
wherein the fixing unit is fixed on the connection face, and a heat unit of the electric heating film is spaced a distance from connection face of the polysurface object.

5. The structure as claimed in claim 4, wherein a maximum value of the distance is not over 2 cm.

6. The structure as claimed in claim 4, wherein the fixing unit has adhesive glue.

7. A structure of configuring a polysurface object comprising:
thepolysurface object having a connection face;
an electric heating film including a fixing unit arranged;
wherein the electric heating film is connected with one or multiple partial zones of the connection face of the polysurface object A via the fixing unit.
